(19) United States
(12) Patent Application Publication
(10) Pub. No.: US 2014/0183214 A1
(43) Pub. Date: Jul. 3, 2014

(54) VENDING MACHINE WITH MOVABLE TRAY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); ZHI-QIANG LI, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/063,094

(22) Filed: Oct. 25, 2013

(30) Foreign Application Priority Data
Dec. 29, 2012 (CN) 2012105891003

(51) Int. Cl. G07F 11/60

(52) U.S. Cl. CPC G07F 11/60
USPC 221/197

(57) ABSTRACT

A vending machine includes a rack, a number of goods carrying modules, a rail, and at least one blocking member. The number of goods carrying modules is located in the rack. The number of goods carrying modules is removable from the rack. The rail is fixed to the rack. At least one guiding slot is defined in the rail. At least one blocking member is slidable along the guiding slot. The blocking member blocks at least one of the number of goods carrying modules from being removed out of the rack.

### BACKGROUND

1. Technical Field

The disclosure generally relates to a vending machine, and especially to a vending machine having a movable tray.

2. Description of Related Art

Vending machines include a plurality of goods carrying modules for carrying different types of goods for sale. The goods carrying modules are aligned in a rack of the vending machine and are pulled out of the rack to stock goods. However, the goods carrying modules are heavy when fully loaded. If two or more goods carrying modules are drawn from the rack at the same time, the rack may topple over. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded, cutaway, view of a vending machine in accordance with one embodiment.

FIG. 2 is an enlarged view of a rail of the vending machine of FIG. 1.

FIG. 3 is an assembled view of the vending machine of FIG. 1.

FIG. 4 is similar to FIG. 3, but shows a goods carrying module in a middle of the rack being removed.

FIG. 5 is similar to FIG. 4, but shows a goods carrying module at a side of the rack being removed.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

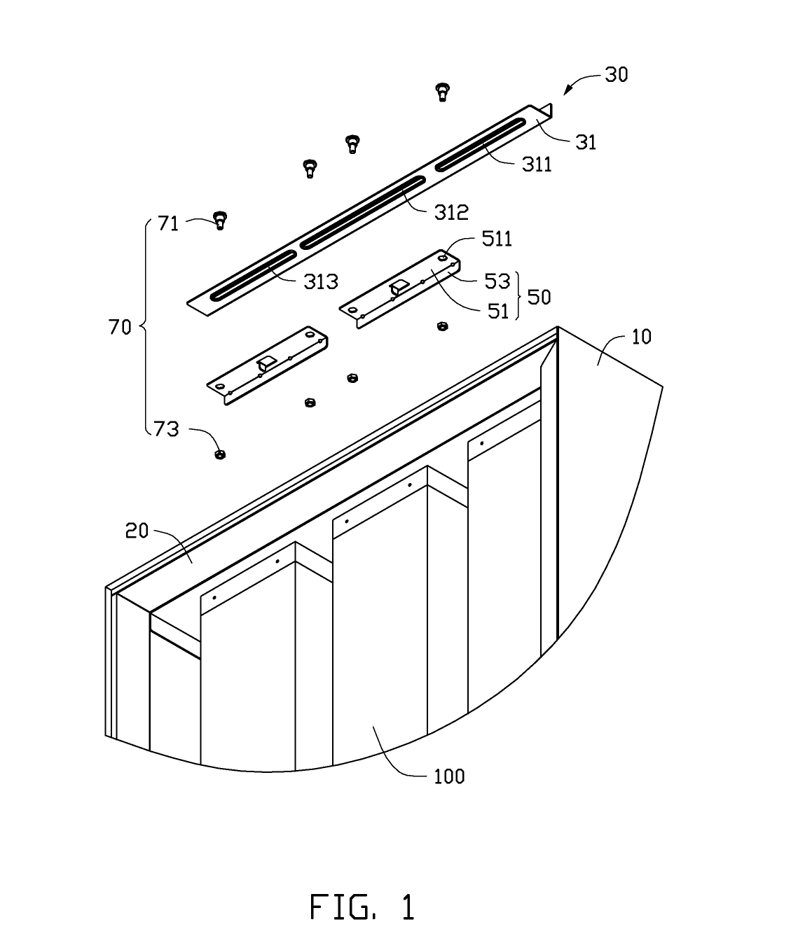

FIG. 1 illustrates an isometric, exploded, cutaway view of a vending machine. The vending machine includes an enclosure 10, a rack 20 located in the enclosure 10, a rail 30, and two blocking members 50. The rack 20 receives three goods carrying modules 100. Each goods carrying module 100 receives a plurality of goods.

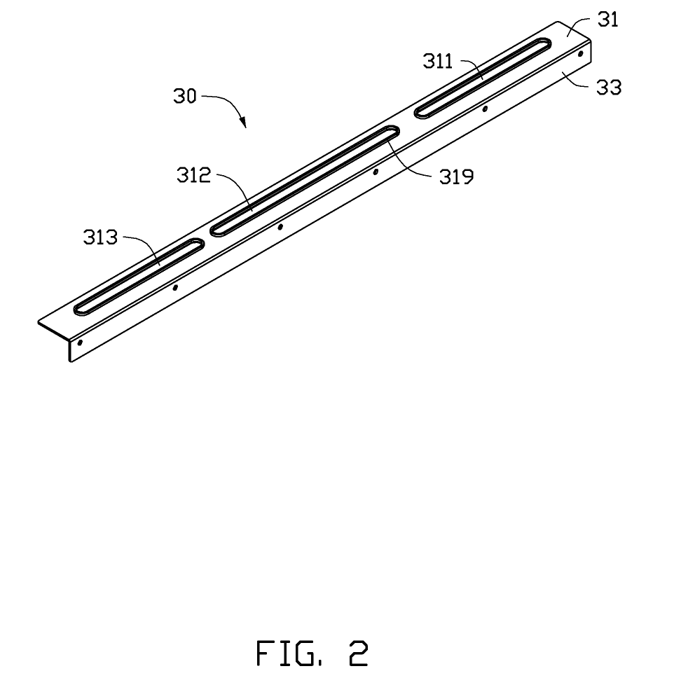

FIG. 2 shows a rail 30 of the vending machine. A cross-section of the rail 30 is substantially L-shaped. The rail 30 includes a fixing portion 33 and a guiding portion 31. A first guiding slot 311, a second guiding slot 312, and a third guiding slot 313 are defined in the guiding portion 31. The first guiding slot 311, the second guiding slot 312, and the third guiding slot 313 are aligned substantially collinearly along a lengthwise direction of the guiding portion 31. The second guiding slot 312 is defined between the first guiding slot 311 and the third guiding slot 313. A length of the second guiding slot 312 is greater than a length of the first guiding slot 311 and a length of the third guiding slot 313. An annular lug 319 protrudes from a perimeter of each of the first guiding slot 311, the second guiding slot 312, and the third guiding slot 313.

The two blocking member 50 are substantially the same. A cross-section of each blocking member 50 is substantially L-shaped. Each blocking member 50 includes a blocking tab 53 and a fixing tab 51. The fixing tab 51 is substantially perpendicular to the blocking tab 53. Two fixing holes 511 are defined in each fixing tab 51. A length of each blocking member 50 is smaller than or equal to a width of each goods carrying module 100.

A plurality of sliding members 70 slidably attaches the blocking members 50 to the rail 30. Two sliding members 70 correspond to the two fixing holes 511 of each blocking member 50. Each sliding member 70 includes a fastener 71 and a nut 73. The fastener 71 is received through the first guiding slot 311, the second guiding slot 312, or the third guiding slot 313 and a corresponding fixing hole 511 of the blocking member 50. The nut 73 is secured to an end of the fastener 71.

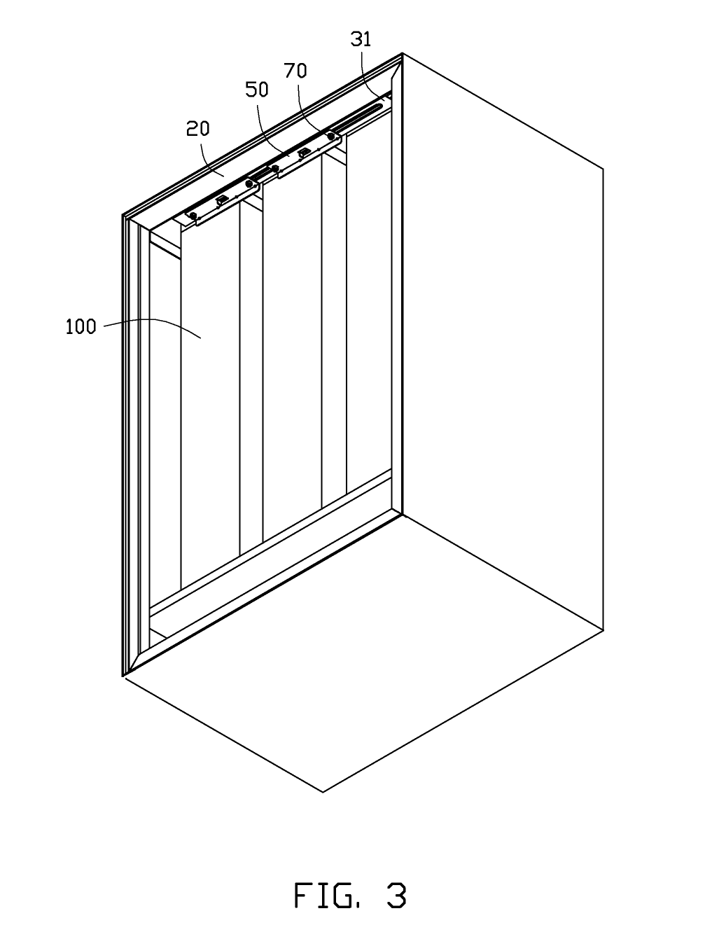

FIG. 3 shows that in assembly, the three goods carrying modules 100 are received in the rack 20. The rail 30 is fixed to a top of the enclosure 10. The two blocking members 50 are slidably mounted to the rail 30 through the plurality of sliding members 70. A first part of a first blocking member 50 is slidable in the first guiding slot 311, and a second part of the first blocking member is slidable in the second guiding slot 312. A first part of a second blocking member 50 is slidable in the second guiding slot 312, and a second part of the second blocking member is slidable in the third guiding slot 313.

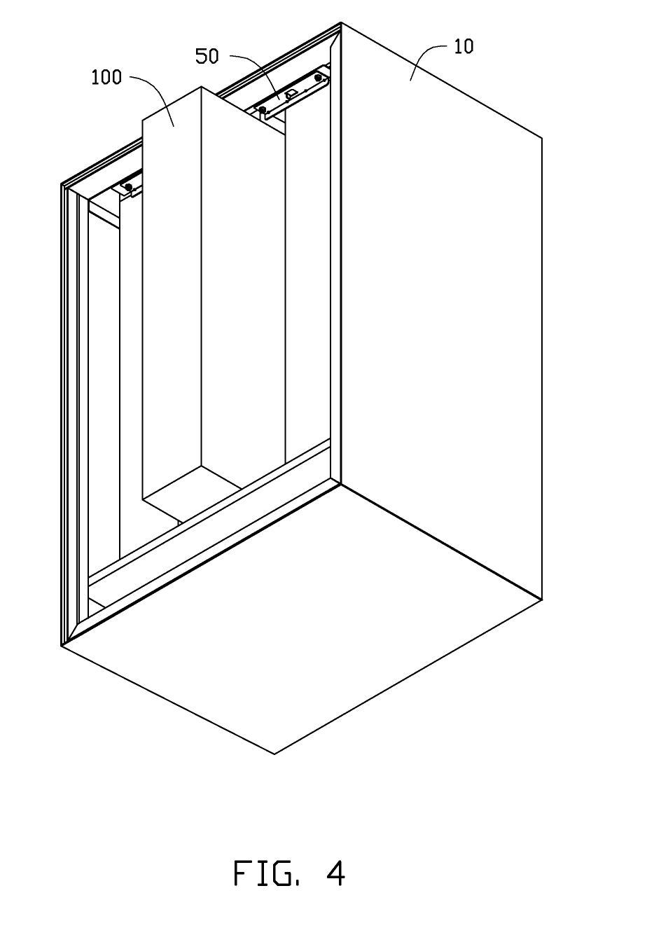

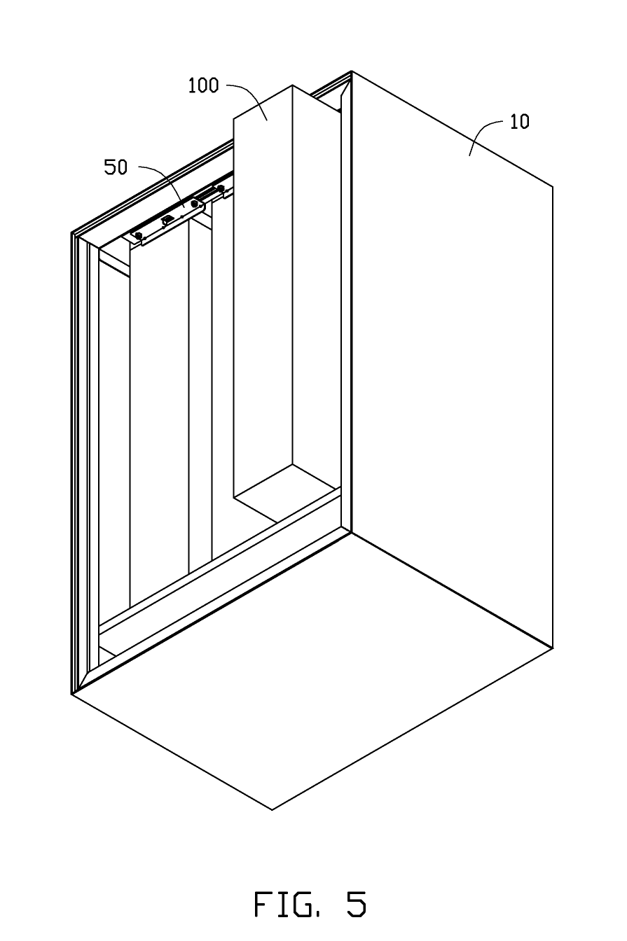

FIG. 4 and FIG. 5 illustrate two removing states of the goods carrying modules 100 of the vending machine. When a goods carrying module 100 in a middle of the rack 20 needs to be removed, the first and second blocking members 50 are slid to a first position. In the first position, the first and second blocking members 50 are at opposite ends of the rail 30 to leave a space in middle of the rail 30 for the goods carrying module 100 in the middle of the rack 20 to be removed. The first and second blocking members 50 block the goods carrying modules 100 at a left side and a right side of the rack 20 from being removed out of the rack 20. The first and second blocking members 50 are slid to different positions to block two goods carrying modules 100 from being removed out of the rack 20 while the other goods carrying module 100 is removed from the rack 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a rack;
a plurality of goods carrying modules located in the rack, and the plurality of goods carrying modules being removable from the rack;
a rail fixed to the rack, and at least one guiding slot defined in the rail; and
at least one blocking member slidable along the at least one guiding slot,
wherein the at least one blocking member is slidable between a first blocking position and a second blocking position; in the first blocking position, the at least one blocking member blocks a first one of the plurality of goods carrying modules from removing out of the rack and gives a removing way to a second one of the plurality of goods carrying modules; and in the second blocking position, the at least one blocking member blocks the second one of the plurality of goods carrying modules from removing out of the rack and give a removing way to the first one of the plurality of goods carrying modules.

2. The vending machine of claim 1, wherein each of the at least one blocking member comprises a fixing tab and a blocking tab, and the fixing tab are substantially perpendicular to the blocking tab.

3. The vending machine of claim 2, wherein a cross-section of each of the at least one blocking member is substantially L-shaped.

4. The vending machine of claim 1, wherein the at least one guiding slot comprises a first guiding slot, a second guiding slot, and a third guiding slot; and the first guiding slot, the second guiding slot, and the third guiding slot are substantially aligned in a straight line.

5. The vending machine of claim 4, wherein the at least one blocking member comprises a first blocking member and a second blocking member; a first portion of the first blocking member is slidable in the first guiding slot, a second portion of the first blocking member is slidable in the second guiding slot; and a first portion of the second blocking member is slidable in the second guiding slot, and a second portion of the second blocking member is slidable in the third guiding slot.

6. The vending machine of claim 4, wherein the second guiding slot is defined between the first guiding slot and the third guiding slot, and a length of the second guiding slot is greater than a length of the first guiding slot and a length of the third guiding slot.

7. The vending machine of claim 1, further comprising at least one sliding member mounted to the at least one blocking member, wherein the at least one blocking member extends through the at least one guiding slot, and the at least one sliding member is slidable relative to the rail.

8. The vending machine of claim 1, wherein a cross-section of the rail is substantially L-shaped.

9. The vending machine of claim 1, wherein a length of each of the at least one blocking member is substantially not greater than a width of each of the plurality of goods carrying modules.

10. The vending machine of claim 1, wherein an annular lug protrudes from the rail along a perimeter of each of the at least one guiding slot towards each of the at least one blocking member.

11. A vending machine, comprising:
a rack;
a plurality of goods carrying modules located in the rack, and the plurality of goods carrying modules being removable from the rack;
a rail fixed to the rack, and at least one guiding slot defined in the rail; and
at least one blocking member slidable along the at least one guiding slot,
wherein the at least one blocking member is configured to block at least one of the plurality of goods carrying modules from removing out of the rack at any position.

12. The vending machine of claim 11, wherein each of the at least one blocking member comprises a fixing tab and a blocking tab, and the fixing tab are substantially perpendicular to the blocking tab.

13. The vending machine of claim 12, wherein a cross-section of each of the at least one blocking member is substantially L-shaped.

14. The vending machine of claim 11, wherein the at least one guiding slot comprises a first guiding slot, a second guiding slot, and a third guiding slot, and the first guiding slot, the second guiding slot, and the third guiding slot are substantially aligned in a straight line.

15. The vending machine of claim 14, wherein the at least one blocking member comprises a first blocking member and a second blocking member; a first portion of the first blocking member is slidable in the first guiding slot, a second portion of the first blocking member is slidable in the second guiding slot; and a first portion of the second blocking member is slidable in the second guiding slot, a second portion of the second blocking member is slidable in the third guiding slot.

16. The vending machine of claim 14, wherein the second guiding slot is defined between the first guiding slot and the third guiding slot, and a length of the second guiding slot is greater than a length of the first guiding slot and a length of the third guiding slot.

17. The vending machine of claim 11, further comprising at least one sliding member mounted to the at least one blocking member, wherein the at least one blocking member extends through the at least one guiding slot, and the at least one sliding member is slidable relative to the rail.

18. The vending machine of claim 11, wherein a cross-section of the rail is substantially L-shaped.

19. The vending machine of claim 11, wherein a length of each of the at least one blocking member is substantially not greater than a width of each of the plurality of goods carrying modules.

20. The vending machine of claim 11, wherein an annular lug protrudes from the rail along a perimeter of each of the at least one guiding slot towards each of the at least one blocking member.
